(19) United States
(12) Patent Application Publication
(10) Pub. No.: US 2026/0228285 A1
(43) Pub. Date: Aug. 6, 2026

(54) INTERACTION METHOD, APPARATUS, ELECTRONIC DEVICE, STORAGE MEDIUM, AND PROGRAM PRODUCT

(71) Applicants: Lemon Inc., Grand Cayman (KY); Beijing Zitiao Network Technology Co., Ltd., Beijing (CN)

(72) Inventors: Junyuan QI, Singapore (SG); Bowen SHEN, Beijing (CN); Yingdi SUN, Beijing (CN)

(21) Appl. No.: 19/399,130

(22) Filed: Nov. 24, 2025

(30) Foreign Application Priority Data
Jan. 24, 2025 (CN) 202510122562.1

(51) Int. Cl. G06F 16/9038; G06F 16/901; G06F 16/904; G06F 40/35

(52) U.S. Cl. CPC G06F 16/9038; G06F 16/901; G06F 16/904; G06F 40/35

(57) ABSTRACT

The present disclosure relates to an interaction method, an interaction apparatus, an electronic device, a storage medium, and a program product, and in particular, to the field of artificial intelligence and computer technologies. The interaction method of the present disclosure includes: receiving first information input by a user in an interaction interface with an agent; determining, based on the first information, a target information platform matching the first information, where the target information platform includes a target multimedia resource matching demand information corresponding to the first information; and displaying the target multimedia resource in the interaction interface between the user and the agent.

### CROSS-REFERENCE TO RELATED APPLICATIONS

This application claims the benefit under 35 USC 119(a) of Chinese Patent Application No. 202510122562.1, filed on January 24, 2025. The entire disclosure of the prior application is hereby incorporated by reference in its entirety.

### TECHNICAL FIELD

The present disclosure relates to the field of artificial intelligence and computer technologies, and in particular, to an interaction method, an apparatus, an electronic device, a storage medium, and a program product.

### BACKGROUND

With the development of Artificial Intelligence (AI) technology, various types of agents have emerged. Agents may interact with users. At present, common dialogue-type agents may be applied in various scenarios.

Dialogue-type agents usually provide information to users in the form of dialogue. For example, a user inputs a question, and an answer replied by the agent is displayed in an interaction interface between the user and the agent.

### SUMMARY

According to some embodiments of the present disclosure, an interaction method is provided, including: receiving first information input by a user in an interaction interface with an agent; determining, based on the first information, a target information platform matching the first information, where the target information platform includes a target multimedia resource matching demand information corresponding to the first information; and displaying the target multimedia resource in the interaction interface between the user and the agent.

According to some other embodiments of the present disclosure, an interaction apparatus is provided, including: a receiving module configured to receive first information input by a user in an interaction interface with an agent; a determination module configured to determine, based on the first information, a target information platform matching the first information, where the target information platform includes a target multimedia resource matching demand information corresponding to the first information; and a display module configured to display the target multimedia resource in the interaction interface between the user and the agent.

According to some further embodiments of the present disclosure, an electronic device is provided, including: a processor; and a memory coupled to the processor and configured to store instructions, where the instructions, when executed by the processor, cause the processor to perform the interaction method according to any one of the embodiments of the present disclosure.

According to some still further embodiments of the present disclosure, a computer-readable storage medium is provided, where a computer program is stored on the computer-readable storage medium, and the computer program, when executed by a processor, causes the processor to perform the interaction method according to any one of the embodiments of the present disclosure.

Other features, aspects, and advantages of the present disclosure become apparent with reference to the following detailed description of the exemplary embodiments of the present disclosure and in conjunction with the drawings.

### BRIEF DESCRIPTION OF THE DRAWINGS

Embodiments of the present disclosure are described hereinafter with reference to the drawings. It is to be understood that the drawings in the following description relate to some embodiments of the present disclosure, but are not intended to limit the present disclosure. In the drawings:

FIG. 1 is a schematic flowchart of an interaction method according to some embodiments of the present disclosure;

FIG. 2 is a schematic diagram of a display interface according to some embodiments of the present disclosure;

FIG. 3 is a schematic flowchart of an interaction method according to some other embodiments of the present disclosure;

FIG. 4 is a schematic diagram illustrating the structure of an interaction apparatus according to some embodiments of the present disclosure;

FIG. 5 is a schematic diagram illustrating the structure of an electronic device according to some embodiments of the present disclosure;

FIG. 6 is a schematic diagram illustrating the structure of an electronic device according to some other embodiments of the present disclosure.

### DETAILED DESCRIPTION

The technical solutions in the embodiments of the present disclosure are described clearly and completely hereinafter with reference to the drawings in the embodiments of the present disclosure. It is to be understood that the present disclosure may be implemented in various forms, and is not to be construed as limited to the embodiments set forth herein.

It is to be understood that the steps described in the method implementations of the present disclosure may be performed in different orders and/or in parallel. In addition, the method implementations may include additional steps and/or omit the steps shown. The scope of the present disclosure is not limited in this respect. Unless otherwise specified, the relative arrangement of the steps set forth in these embodiments is to be construed as merely exemplary, and does not limit the scope of the present disclosure.

The term "include/comprise" and its variants used in the present disclosure mean open terms that include/comprise at least the following elements/features, but do not exclude other elements/features, that is, "include/comprise but not limited to". The term "based on" means "at least partially based on".

It is to be noted that the concepts of "first" and "second" mentioned in the present disclosure are merely intended to distinguish between different apparatuses, modules, or units, and are not intended to limit the order or interdependence of the functions performed by these apparatuses, modules, or units. Unless otherwise specified, the concepts of "first" and "second" are not intended to imply that the objects so described must be in a given order in terms of time, space, ranking, or in any other way.

It is to be noted that the modifiers "one" and "a plurality of" mentioned in the present disclosure are illustrative and not restrictive, and those skilled in the art should understand that "one" or "a plurality of" should be understood as "one or more" unless otherwise clearly indicated in the context.

Embodiments of the present disclosure are described in detail hereinafter with reference to the drawings, but the present disclosure is not limited to these specific embodiments. The following specific embodiments may be combined with each other, and the same or similar concepts or processes may not be described in detail in some embodiments. In addition, in one or more embodiments, a particular feature, structure, or characteristic may be combined in any suitable manner that will be clear to those of ordinary skill in the art from the present disclosure.

Dialogue-type agents usually provide information to users in the form of dialogue, and in some cases, the agents also provide some search results to users. Usually, corresponding information platforms (for example, applications or websites) are configured for the agents in advance. After receiving the information input by the users, these information platforms are searched according to the information input by the users to obtain search results. However, due to different focuses and features of different information platforms, in many cases, the search results cannot satisfy the needs of the users when searching in some pre-configured information platforms. If the users want to obtain search results that better meet their needs, they need to decide which information platform to go to and perform the search on their own.

For the foregoing reasons, the present disclosure provides an interaction method. In the method, in response to receiving first information input by a user in an interaction interface with an agent, a target information platform matching the first information is determined based on the first information, where the target information platform includes a target multimedia resource matching demand information corresponding to the first information; and the target multimedia resource is displayed in the interaction interface between the user and the agent. Since the target information platform matches the first information and includes the target multimedia resource matching the demand information corresponding to the first information, rather than any pre-configured information platform, the displayed target multimedia resource may meet the needs of the user, and the accuracy of the displayed target multimedia resource is improved. The target multimedia resource is directly displayed in the interaction interface between the user and the agent, and the user does not need to determine the target information platform or perform a search in the target information platform, so that the display efficiency of the target multimedia resource is improved.

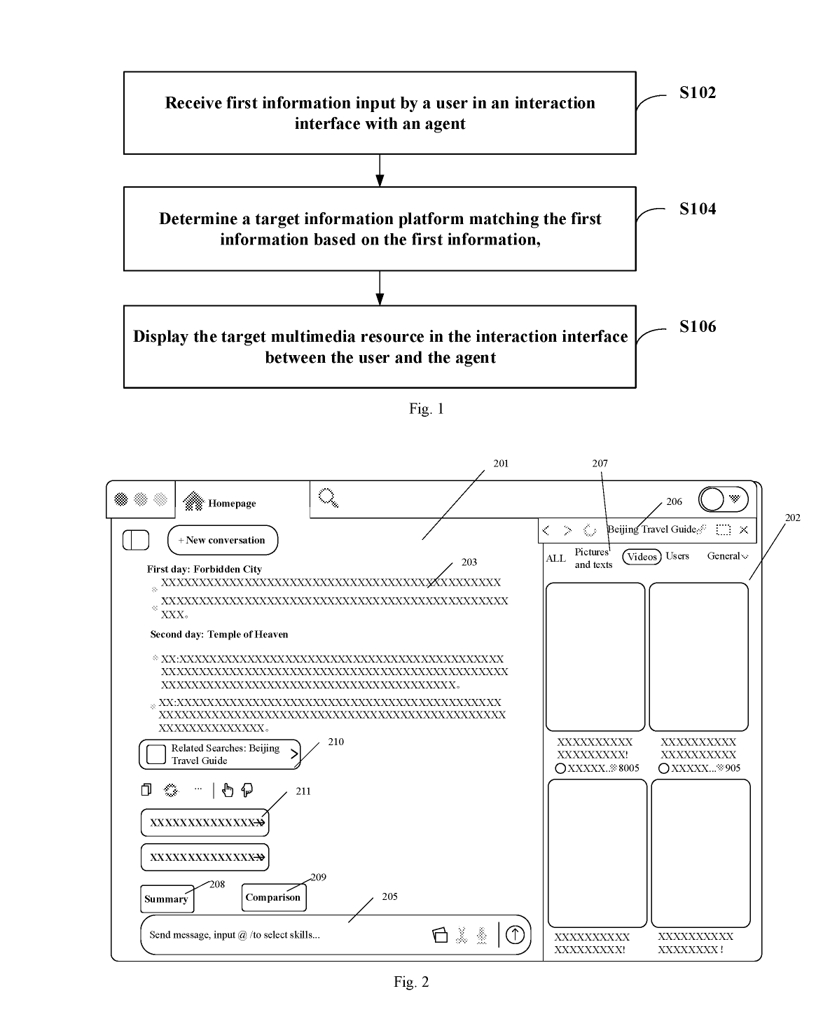

The interaction method of the present disclosure is described hereinafter with reference to FIG. 1 to FIG. 3.

FIG. 1 is a flowchart of some embodiments of an interaction method of the present disclosure. As shown in FIG. 1, the method in this embodiment includes steps S102 to S106. The method in this embodiment may be performed by an agent, or an application or apparatus including the agent. The agent may be implemented by software or a combination of software and hardware.

In step S102, first information input by a user in an interaction interface with the agent is received.

For example, the interaction interface with the agent may be displayed on a terminal device of the user, or the interaction interface may be displayed by another display device, which is not limited to the examples shown. The user may input the first information by text, voice, image, video, or the like.

In step S104, a target information platform matching the first information is determined based on the first information.

One or more target information platforms matching the first information may be determined from a plurality of information platforms. The target information platform may include a platform belongs to at least one type of application and website. The target information platform includes a target multimedia resource matching demand information corresponding to the first information. For example, a search may be performed in the target information platform according to the demand information corresponding to the first information to obtain the matching target multimedia resource. The target multimedia resource may include content of at least one type of text, image, audio, and video. One or more target multimedia resources may exist.

In step S106, the target multimedia resource is displayed in the interaction interface between the user and the agent.

A display style of the target multimedia resource may be the same as or different from that in the target information platform. For example, a thumbnail of the target multimedia resource may be displayed, and in response to a trigger operation of the user on the thumbnail, the target multimedia resource is enlarged for display or played. A page of the target information platform may be displayed in the interaction interface between the user and the agent, and the target multimedia resource may be displayed in the page of the target information platform, or the target multimedia resource may be directly displayed in the interaction interface between the user and the agent. The target multimedia resource may be displayed by a variety of methods, which is not limited to the examples shown.

In the method in the above embodiment, since the target information platform matches the first information and includes the target multimedia resource matching the demand information corresponding to the first information, rather than any pre-configured information platform, the displayed target multimedia resource may meet the needs of the user, and the accuracy of the displayed target multimedia resource is improved. The target multimedia resource is directly displayed in the interaction interface between the user and the agent, and the user does not need to determine the target information platform or perform a search in the target information platform, so that the display efficiency of the target multimedia resource is improved, and the user experience is enhanced.

How to determine the target information platform matching the first information is described hereinafter.

In some embodiments, the determining, based on the first information, a target information platform matching the first information includes: determining, based on semantic information of the first information, demand information corresponding to the first information; and determining, based on the demand information, the target information platform matching the demand information.

For example, a machine learning model may be used to perform semantic understanding on the first information to determine the demand information corresponding to the first information. For example, the machine learning model may be an LLM (Large Language Model), which is not limited to the example shown. The demand information corresponding to the first information may also be determined in combination with semantic information of context of the first information, and then the target information platform matching the demand information is determined. For example, the first information input by the user is "I want to relax and listen to a song", the demand information corresponding to the first information may be determined as searching for a relaxing song, and the determined target information platform may be a music playing platform.

The demand information is determined by performing semantic understanding on the first information, and then the target information platform is determined, which better meets the needs of the user, and a more accurate target multimedia resource that meets the needs may be displayed for the user.

In some embodiments, the determining, based on semantic information of the first information, demand information corresponding to the first information includes: determining, based on the semantic information of the first information, basic demand information corresponding to the first information; expanding the basic demand information to obtain expanded demand information; and determining at least one of the basic demand information or the expanded demand information as the demand information.

The basic demand information may be determined based on the first information, and the basic demand information may be expanded to obtain the expanded demand information. The basic demand information may be expanded in combination with the context of the first information. For example, the user has previously mentioned that "I like singer A", and the first information is "I want to relax and listen to a song", the basic demand information may be determined as searching for a relaxing song, and the expanded demand information is searching for a relaxing song by singer A. The basic demand information may be expanded associatively. For example, the basic demand information is introduction information of the Great Wall, and the expanded demand information is a travel guide of the Great Wall. Association expansion may be performed according to a keyword in the basic demand information. For example, the keyword in the basic demand information is "science fiction", and keywords such as "alien" may be expanded, to obtain the expanded demand information.

For example, a machine learning model is used to expand the basic demand information to obtain the expanded demand information. The machine learning model may be an LLM or the like. The above is an example for ease of understanding of the basic demand information and the expanded demand information, and the internal logic of the actual machine learning model is not necessarily consistent with the above example.

By determining the basic demand information and the expanded demand information, a more diverse and accurate type of target information platform may be matched for the user, and then a more accurate and rich target multimedia resource may be determined, thereby improving the user experience.

How to determine the target information platform matching the demand information is described hereinafter.

In some embodiments, the basic demand information corresponds to a first demand category, the expanded demand information corresponds to a second demand category, and the determining, based on the demand information, the target information platform matching the demand information includes: determining an information platform corresponding to at least one of the first demand category or the second demand category as the target information platform.

The basic demand information may include the first demand category, and the expanded demand information may include the second demand category. For example, a machine learning model is used to perform semantic understanding on the first information and then classify the first information to obtain the first demand category, and the second demand category may be obtained by expanding the first demand category. For example, one or more demand categories associated with the first demand category are determined as the second demand category according to the first demand category.

The first demand category may also be determined based on the first information or the basic demand information, and the second demand category is determined based on the expanded demand information. For example, the first information is "Please introduce the history of the Great Wall", the first demand category may be determined as a "knowledge category". The second demand category obtained through expansion is a "travel guide category".

A demand category corresponding to each of the plurality of information platforms may be determined in advance based on interaction data of resources of each of the plurality of information platforms. For example, among the plurality of information platforms, if the interaction volume of the resources of the "travel guide category" in an information platform A is the largest or exceeds a threshold, the information platform A may be set to correspond to the "travel guide category". The interaction volume of the resources may be measured by at least one indicator of click volume, search volume, comment volume, and like volume. One information platform may correspond to one or more demand categories.

A correspondence between the information platforms and the demand categories may be stored in a database, and the corresponding information platform is searched for in the database as the target information platform according to at least one of the first demand category and the second demand category.

According to the method in the above embodiment, the first demand category and the second demand category are determined based on the first information, and then the corresponding target information platform is determined based on the first demand category and the second demand category, so that the accuracy of determining the target information platform may be improved. In addition, according to the expanded second demand category, the type of the matched target information platform may be increased, and the target multimedia resource that is richer in content and better meets the needs of the user may be provided for the user.

In some embodiments, the determining, based on the demand information, the target information platform matching the demand information includes: obtaining index information of the plurality of information platforms, where the index information includes summary information of multimedia resources of each of the plurality of information platforms; and determining, based on semantic information of the demand information and the summary information of the multimedia resources of each of the plurality of information platforms, the target information platform matching the demand information from the plurality of information platforms.

An index library of information platforms may be established. For each information platform, semantic understanding may be performed on the multimedia resources in the information platform, to generate the summary information of the multimedia resources. For example, a title, content, or the like of each multimedia resource may be understood to generate summary information of each multimedia resource, or multimedia resources of a same type may be summarized to obtain summary information of each type of multimedia resources, or interaction data of each multimedia resource may be summarized, or interaction data of each type of multimedia resources may be summarized to obtain the summary information. For example, the summary information of the multimedia resources of each information platform includes at least one of summary information of each multimedia resource in the information platform, summary information of each type of multimedia resources in the information platform, summary information of interaction data of each multimedia resource in the information platform, or summary information of interaction data of each type of multimedia resources in the information platform.

The semantic information of the demand information may be matched with the semantic information of the summary information of the multimedia resources of each information platform to determine the target information platform matching the demand information from the plurality of information platforms.

In the method in the above embodiment, the index library of the information platforms is constructed to include the summary information of the multimedia resources of each information platform, and then the demand information is matched with the summary information to obtain the target information platform, which may improve the accuracy of determining the target information platform, thereby improving the accuracy of the determined target multimedia resource, better meeting the needs of the user, and enhancing the user experience.

Reply information generated based on the first information may also be displayed in the interaction interface between the user and the agent. For example, a machine learning model is used to generate the reply information based on the semantic information of the first information. For example, the first information is "Please introduce the history of the Great Wall", and the generated reply information may be introduction information of the history of the Great Wall. For example, the reply information may be generated based on the semantic information of the first information and the semantic information of the target multimedia resource. The reply information may include summary information of the target multimedia resource. The reply information may also include guidance information corresponding to the target multimedia resource. The guidance information may be generated based on the target information platform and the target multimedia resource. For example, the guidance information is "A video about the history of the Great Wall is also found for you in information platform X, please take a look".

The reply information is generated based on the target multimedia resource and the first information, so that the displayed reply information is correlated with the target multimedia resource, and the user may better understand the reply information and the target multimedia resource, thereby improving the overall display effect.

A solution of how to display the reply information and the target multimedia resource is described hereinafter with reference to FIG. 2.

In some embodiments, the interaction interface between the user and the agent includes a first column and a second column, the reply information generated based on the first information is displayed in the first column, and the target multimedia resource is displayed in the second column.

The reply information and the target multimedia resource may be displayed in a double-column display manner. Different contents are displayed in the two columns, and different interaction operations may be performed in the two columns. For example, the first column may include an input area and a display area for interaction between the user and the agent and display of interaction information, and the target multimedia resource is displayed in the second column. The user may interact with the target multimedia resource, for example, by triggering an operation of the target multimedia resource to enlarge the target multimedia resource for display, play the target multimedia resource, jump to the target information platform, or the like.

For example, a page of the target information platform may be displayed in the second column, and the target multimedia resource may be displayed in the page. For example, if the target information platform is a website, a web page may be displayed in the second column and the target multimedia resource may be displayed in the web page, and the display effect of the web page may be the same as or similar to that of the web page opened through a browser. For example, if the target information platform is an application (including a mini-program and the like), a page of the application may be displayed in the second column, and the target multimedia resource may be displayed in the page of the application.

As shown in FIG. 2, the interaction interface between the user and the agent includes a first column 201 and a second column 202, reply information 203 may be displayed in the first column, and a plurality of target multimedia resources 204 may be displayed in the second column. The first column may also include an input area 205, and the user may input information by text, voice, or the like. Each target multimedia resource may display a corresponding name, the number of likes, an author identification, or the like.

The reply information and the target multimedia resource are displayed in different columns, and different types of content are displayed in different columns, so that the user may quickly locate the area where the required information is located according to his/her own needs, thereby improving the reading efficiency and accuracy. In addition, the reply information and the target multimedia resource may be displayed at the same time without page jumping, which facilitates the reading of the user and reduces the operations of the user.

The target multimedia resource may be obtained by the following method.

In some embodiments, the displaying the target multimedia resource in the interaction interface between the user and the agent includes: determining, based on the semantic information of the first information, a search term; generating, based on the search term, second information corresponding to the target information platform; sending the second information to the target information platform; and displaying, in the interaction interface between the user and the agent, a search result obtained by the target information platform based on the second information, as the target multimedia resource.

A keyword may be extracted as the search term according to the semantic information of the first information, or the search term may be generated according to the demand information corresponding to the first information. The search term may be directly used as the second information, or the second information may be generated by expanding the search term. For example, a link corresponding to the target information platform is generated according to the second information, and a request is sent to the target information platform through the link, where the request includes the second information. Then, the search result returned by the target information platform is obtained and displayed in the interaction interface between the user and the agent as the target multimedia resource. For example, the link is a URL (Uniform Resource Locator), or the like, and the second information may be concatenated to the search URL of the target information platform.

According to the method in the above embodiment, the target information platform may be searched more accurately, and the more accurate target multimedia resource that better meets the needs of the user may be obtained.

In some embodiments, the displaying the target multimedia resource in the interaction interface between the user and the agent includes: determining, based on the semantic information of the first information, a search term and a search result type; generating, based on the search term and the search result type, second information corresponding to the target information platform; sending the second information to the target information platform; and displaying, in the interaction interface between the user and the agent, a search result obtained by the target information platform based on the second information, as the target multimedia resource.

In addition to determining the search term, the search result type may also be determined according to the semantic information of the first information or the demand information corresponding to the first information. For example, if the first information includes a keyword corresponding to the search result type, the search result type is determined according to the keyword. For example, the first information is "I want to relax and listen to a song", and the search result type may be determined as an audio and/or a video.

For example, the demand information includes at least one of the basic demand information or the expanded demand information, the basic demand information corresponds to the first demand category, and the expanded demand information corresponds to the second demand category. The search result type may be determined according to at least one of the first demand category or the second demand category. For example, a correspondence between demand categories and search result types may be pre-configured. For example, the search result type corresponding to the travel guide category is a video and/or a picture and text, or the like.

For example, a machine learning model is used to determine the search result type based on the semantic information of the first information. The machine learning model may perform semantic understanding on the first information to determine an appropriate search result type.

As shown in FIG. 2, the search term 206 and the search result type 207 may also be displayed in the second column. For example, the page of the target information platform is displayed in the second column, the search term is displayed in a search area of the page, the page may include a plurality of tab pages, and the target multimedia resource is displayed in a tab page corresponding to the search result type.

In the method in the above embodiment, the search term and the search result type are determined based on the first information, and the type of the determined target multimedia resource may better meet the needs of the user, and the accuracy of the displayed target multimedia resource is improved.

The user may modify the second information to obtain a new search result. For example, the second information is also displayed in the target information platform, and the interaction method further includes: in response to the modification of the second information by the user, sending modified second information to the target information platform; and displaying, in the interaction interface between the user and the agent, a search result obtained by the target information platform based on the modified second information.

For example, the user may modify the search term or the search result type. As shown in FIG. 2, the user may directly modify the search term in the search area in the second column, or may modify the search result type by switching the tab page. The user may also input, in the first column, the prompt information for modifying the second information. In response to the user inputting the prompt information for modifying the second information, the modified second information is generated based on the prompt information. For example, the user inputs "Please replace it with a picture and text about a food guide in Beijing".

Alternatively, the user may re-input information, and based on the method in the previous embodiment, the target information platform and the target multimedia resource may be re-determined and displayed, which will not be repeated herein.

The user may also perform further interaction on the target multimedia resource to generate new content.

In some embodiments, a generation control is displayed in the first column, and the interaction method further includes: in response to a selection operation of the user on one or more multimedia resources in the target multimedia resource and a trigger operation of the user on the generation control, generating, based on the one or more multimedia resources, target content; and displaying the target content in the first column.

The user may select one or more multimedia resources in the second column by clicking or other preset operations, and may further trigger the generation control in the first column, to generate the target content. Alternatively, the generation control may be triggered first, and then one or more multimedia resources may be selected. For example, a machine learning model may be used to perform semantic understanding on the one or more multimedia resources to generate the target content. The generated target content may be content of at least one type of text, audio, video, and image. The target content may be displayed on an upper layer of the second column, for example, in a floating layer, a mask layer, or a window on the upper layer of the second column, which is not limited to the examples shown.

The generation control may also be displayed in the second column or on an upper layer of the second column.

In some embodiments, the interaction method further includes: in response to a selection operation of the user on one or more multimedia resources in the target multimedia resource, displaying a generation control on an upper layer of the second column; in response to a trigger operation of the user on the generation control, generating, based on the one or more multimedia resources, target content; and displaying the target content in the first column.

For example, the generation control may be displayed in the floating layer or the mask layer on the upper layer of the second column, which is not limited to the examples shown.

According to the solution in the above embodiment, the user may select one or more multimedia resources through a simple operation to generate the new target content, thereby improving the efficiency of generating the target content. The user does not need to view and understand each multimedia resource completely, and may obtain the desired content more quickly and accurately, which better meets the needs of the user and improves the user experience.

One or more generation controls of different types may exist. For example, the generation control may include at least one of a summary control and a comparison control.

In some embodiments, the generation control includes a control configured to summarize the one or more multimedia resources, and the generating, based on the one or more multimedia resources, the target content includes: summarizing, based on semantic information of the one or more multimedia resources, the one or more multimedia resources to generate summary information as the target content.

The control for summarizing the one or more multimedia resources is the summary control. As shown in FIG. 2, the summary control 208 may be displayed in the first column. The summary control 208 may also be displayed in the second column or on the upper layer of the second column. For example, a machine learning model is used to understand the semantic information of each multimedia resource, and then the summary information is generated by summarizing.

According to the method in the above embodiment, the user may select one or more multimedia resources and ask the agent to summarize them, which saves the time of the user to view all the content and facilitates the operation and reading of the user, thereby improving the efficiency.

In some embodiments, the one or more multimedia resources include a plurality of multimedia resources, the generation control includes a control configured to compare the plurality of multimedia resources, and the generating, based on the one or more multimedia resources, the target content includes: comparing, based on semantic information of the plurality of multimedia resources, the plurality of multimedia resources to generate comparison information as the target content.

The control for comparing the plurality of multimedia resources is the comparison control. As shown in FIG. 2, the comparison control 209 may be displayed in the first column. The comparison control 209 may also be displayed in the second column or on the upper layer of the second column. For example, a machine learning model is used to understand the semantic information of each multimedia resource, and the plurality of multimedia resources are compared to generate the comparison information. For example, for two videos about a travel guide in Beijing, the difference in scenic spots to go to may be determined by comparison.

According to the method in the above embodiment, the user may select a plurality of multimedia resources and ask the agent to perform comparison, which saves the time of the user to view all the content, and enables the user to quickly and accurately determine the difference information between different multimedia resources.

The generation control may also include a type conversion control. For example, in response to a trigger operation of the user on the type conversion control, the one or more multimedia resources may be converted into a preset type. For example, a video is converted into a picture and text, or the like.

In addition to using the generation control to quickly and accurately obtain the desired target content, the user may also generate the target content by inputting the prompt information.

In some embodiments, the interaction method further includes: receiving the prompt information input by the user in the first column or the second column, where the prompt information includes selection information of one or more multimedia resources in the target multimedia resource; generating, based on the prompt information and the one or more multimedia resources, the target content; and displaying the target content in the first column.

An input area may also be provided in the second column, and the user may input the prompt information in the second column. The prompt information includes the selection information of the one or more multimedia resources. The prompt information may also include at least one of a theme or a type of the target content. A machine learning model may be used to perform semantic understanding on the prompt information and perform semantic understanding on the one or more multimedia resources to generate the target content that meets at least one of the theme or the type. For example, the prompt information is "Please generate a summary text based on the first video and the second video". If the user does not input the type of the target content, the machine learning model may be used to determine the type corresponding to the target content according to the prompt information and the type of the multimedia resources, so as to match the needs of the user.

According to the method in the above embodiment, the user may more flexibly control the generation of the target content by inputting the prompt information, and the target content with more types and richer themes may be generated, which better meets the needs of the user and improves the user experience.

In some other embodiments, in response to a selection operation of the user on one or more multimedia resources in the target multimedia resource and prompt information input by the user in the first column or the second column, where the prompt information includes at least one of the theme or the type of the target content, the target content is generated based on the prompt information and the one or more multimedia resources; and the target content is displayed in the first column.

The user may directly select the one or more multimedia resources without carrying the selection information in the prompt information, which is more convenient. The user only needs to input at least one of the theme or the type of the target content, thereby reducing the information input and improving the operation efficiency.

The user may also specify a reference part of each multimedia resource in the prompt information.

In some embodiments, the prompt information includes at least one of the theme or the type of the target content and information indicating a reference part of each of the one or more multimedia resources, and the generating, based on the prompt information and the one or more multimedia resources, the target content includes: determining, based on semantic information of the prompt information and each of the one or more multimedia resources, the reference part of each of the one or more multimedia resources; and summarizing, based on at least one of the theme or the type of the target content and semantic information of the reference part of each of the one or more multimedia resources, the one or more multimedia resources to generate the target content.

For example, the prompt information input by the user is "Please generate a travel guide based on the hotel in video 1 and the scenic spot in video 2". A machine learning model may be used to perform semantic understanding on the prompt information to determine the reference part of each multimedia resource specified by the user, perform semantic understanding on the one or more multimedia resources to determine the content of the reference part of each multimedia resource, and then generate, based on the content of the reference part of each multimedia resource, the target content that meets at least one of the theme or the type in the prompt information.

According to the method in the above embodiment, the user may input the prompt information to generate richer and more diverse target content, and the generated target content better meets the needs of the user, thereby improving the efficiency and accuracy of generating the target content.

The user may also further ask questions about one or more multimedia resources in the target multimedia resource.

In some embodiments, the interaction method further includes: in response to the user inputting question information for one or more multimedia resources in the target multimedia resource, generating an answer based on the question information and the one or more multimedia resources; and displaying the answer in the interaction interface between the user and the agent.

For example, the user may ask the agent "What hotel is stayed in video 1". The machine learning model may be used to perform semantic understanding on the one or more multimedia resources and generate the answer corresponding to the question information.

According to the method in the above embodiment, the user may perform in-depth interaction with the agent on the one or more multimedia resources, and the content that the user wants to know may be located more accurately and quickly, thereby improving the reading efficiency.

As shown in FIG. 2, the first column may further include a control 210 corresponding to the target information platform. In response to the user triggering the control 210, the target information platform may be jumped to and the target multimedia resource is displayed. A control 211 of one or more candidate questions related to the first information may also be displayed in the first column. In response to the user triggering a control of a target question in the one or more candidate questions, an answer generated based on the target question is displayed. For example, the machine learning model is used to generate one or more associated questions based on the first information as the one or more candidate questions. For example, the first information is "a travel guide in Beijing", and the one or more candidate questions may be "a food guide in Beijing", "scenic spots in Beijing", or the like.

In each of the above embodiments, the user may perform further interaction with the agent on the target multimedia resource, and the agent may provide a generation function for the user as an assistant and help the user answer related questions, which facilitates the operation of the user and assists the user to quickly and accurately understand the target multimedia resource, thereby improving the user experience.

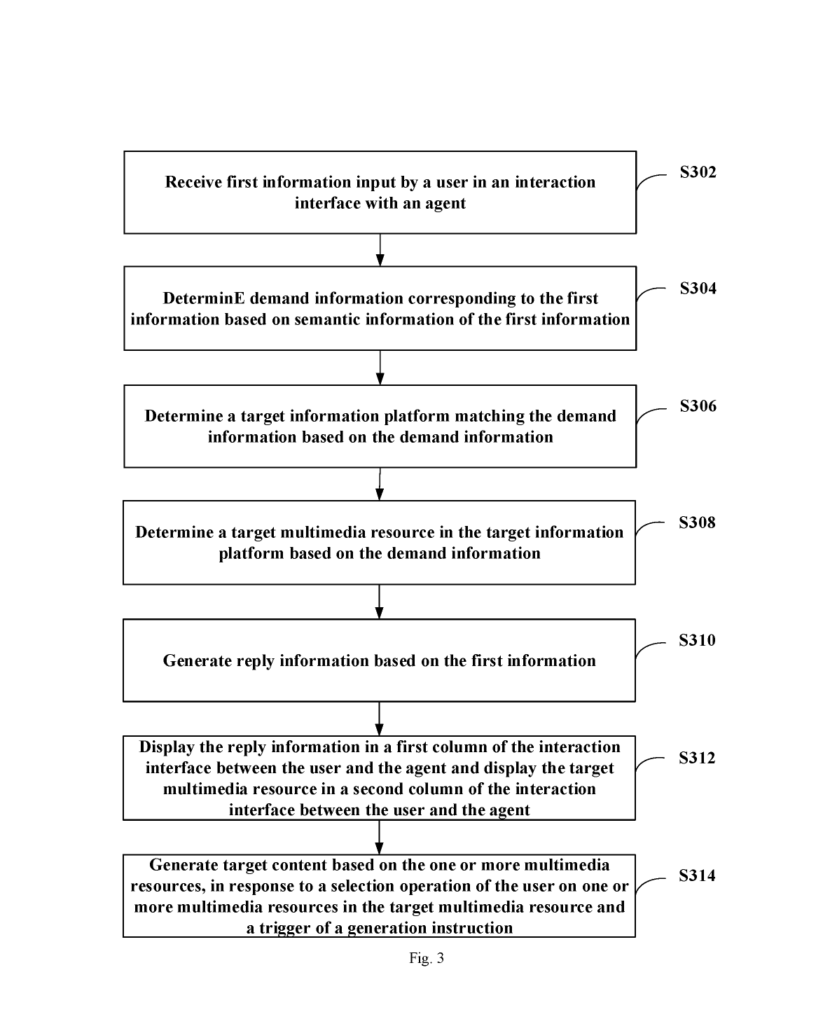

FIG. 3 is a flowchart of some other embodiments of an interaction method according to the present disclosure. As shown in FIG. 3, the method in this embodiment includes steps S302 to S314.

In step S302, first information input by a user in an interaction interface with an agent is received.

In step S304, demand information corresponding to the first information is determined based on semantic information of the first information.

In step S306, a target information platform matching the demand information is determined based on the demand information.

In step S308, a target multimedia resource in the target information platform is determined based on the demand information.

In step S310, reply information is generated based on the first information.

In step S312, the reply information is displayed in a first column of the interaction interface between the user and the agent, and the target multimedia resource is displayed in a second column of the interaction interface between the user and the agent.

In step S314, in response to a selection operation of the user on one or more multimedia resources in the target multimedia resource and a trigger of a generation instruction, target content is generated based on the one or more multimedia resources.

The user may select the one or more multimedia resources and trigger the generation instruction (summarize, compare, or the like) through a control, prompt information, or the like, which may be referred to the previous embodiments, and details are not repeated herein.

According to the method in the above embodiment, for the first information input by the user, the target information platform that meets the needs of the user may be automatically determined, the target multimedia resource in the target information platform is determined, and the reply information is generated. The reply information and the target multimedia resource are simultaneously displayed in the interaction interface in the form of double columns, and the user may also perform further in-depth interaction with the agent on the one or more multimedia resources. According to the method in the above embodiment, the accuracy and efficiency of displaying the target multimedia resource are improved, and the agent, as an assistant, may assist the user to understand and generate the content that meets the needs of the user, thereby improving the accuracy and efficiency.

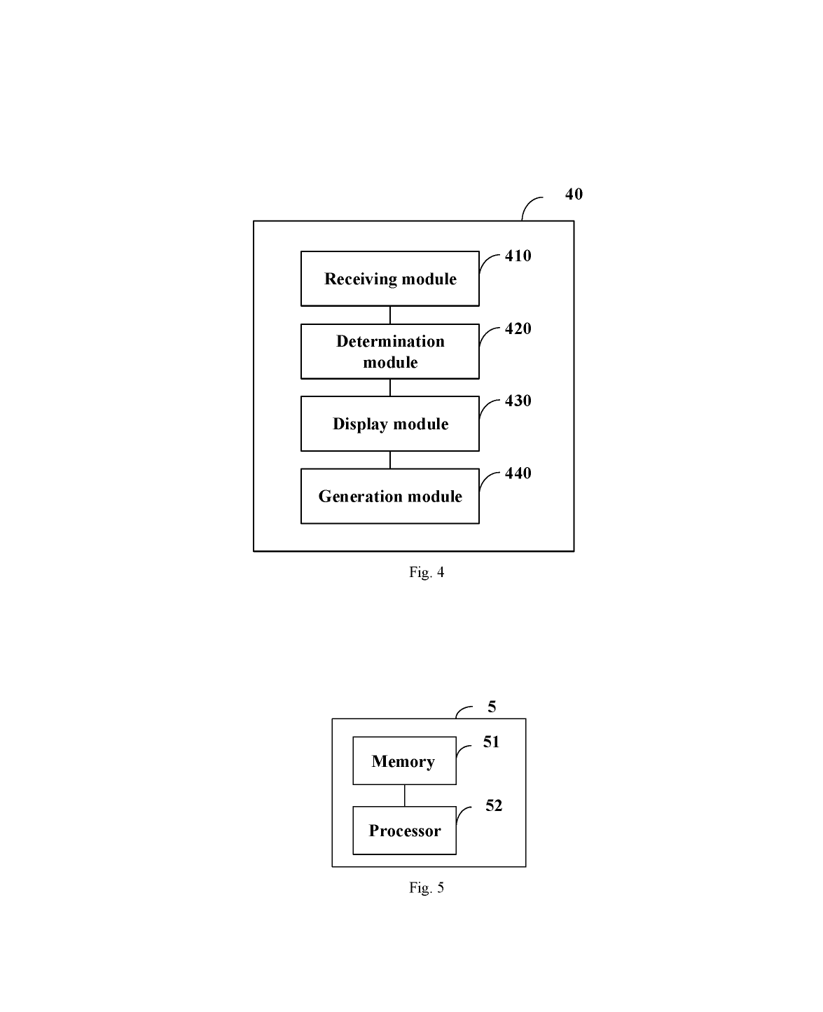

The present disclosure further provides an interaction apparatus, which is described hereinafter with reference to FIG. 4.

FIG. 4 is a structural diagram of some embodiments of an interaction apparatus according to the present disclosure. As shown in FIG. 4, the interaction apparatus 40 in this embodiment includes a receiving module 410, a determination module 420, and a display module 430.

The receiving module 410 is configured to receive first information input by a user in an interaction interface with an agent.

The determination module 420 is configured to determine, based on the first information, a target information platform matching the first information, where the target information platform includes a target multimedia resource matching demand information corresponding to the first information.

The display module 430 is configured to display the target multimedia resource in the interaction interface between the user and the agent.

In some embodiments, the determination module 420 is configured to determine, based on semantic information of the first information, the demand information corresponding to the first information, and determine, based on the demand information, the target information platform matching the demand information .

In some embodiments, the determination module 420 is configured to determine, based on the semantic information of the first information, basic demand information corresponding to the first information; expand the basic demand information to obtain expanded demand information; and determine at least one of the basic demand information or the expanded demand information as the demand information.

In some embodiments, the basic demand information corresponds to a first demand category, the expanded demand information corresponds to a second demand category, and the determination module 420 is configured to determine an information platform corresponding to at least one of the first demand category or the second demand category as the target information platform.

In some embodiments, the determination module 420 is configured to obtain index information of a plurality of information platforms, where the index information includes summary information of multimedia resources of each of the plurality of information platforms; and determine, based on semantic information of the demand information and the summary information of the multimedia resources of each of the plurality of information platforms, the target information platform matching the demand information from the plurality of information platforms.

In some embodiments, the interaction interface between the user and the agent includes a first column and a second column, reply information generated based on the first information is displayed in the first column, and the target multimedia resource is displayed in the second column.

In some embodiments, a generation control is displayed in the first column, and the interaction apparatus further includes: a generation module 440 configured to, in response to a selection operation of the user on one or more multimedia resources in the target multimedia resource and a trigger operation of the user on the generation control, generate, based on the one or more multimedia resources, target content; and the display module 430 is further configured to display the target content in the first column.

In some embodiments, the display module 430 is further configured to, in response to a selection operation of the user on one or more multimedia resources in the target multimedia resource, display a generation control on an upper layer of the second column; the interaction apparatus further includes a generation module 440 configured to, in response to a trigger operation of the user on the generation control, generate, based on the one or more multimedia resources, target content; and the display module 430 is further configured to display the target content in the first column.

In some embodiments, the generation control includes a control configured to summarize the one or more multimedia resources, and the generation module 440 is configured to summarize, based on semantic information of the one or more multimedia resources, the one or more multimedia resources to generate summary information as the target content.

In some embodiments, the one or more multimedia resources include a plurality of multimedia resources, the generation control includes a control configured to compare the plurality of multimedia resources, and the generation module 440 is configured to compare, based on semantic information of the plurality of multimedia resources, the plurality of multimedia resources to generate comparison information as the target content.

In some embodiments, the receiving module 410 is further configured to receive prompt information input by the user in the first column or the second column, where the prompt information includes selection information of one or more multimedia resources in the target multimedia resource; the interaction apparatus further includes a generation module 440 configured to generate, based on the prompt information and the one or more multimedia resources, the target content; and the display module 430 is further configured to display the target content in the first column.

In some embodiments, the prompt information includes at least one of a theme or a type of the target content and information indicating a reference part of each of the one or more multimedia resources, and the generation module 440 is configured to determine, based on semantic information of the prompt information and each of the one or more multimedia resources, the reference part of each of the one or more multimedia resources; and summarize, based on at least one of the theme or the type of the target content and semantic information of the reference part of each of the one or more multimedia resources, the one or more multimedia resources to generate the target content.

In some embodiments, the determination module 420 is further configured to determine, based on the semantic information of the first information, a search term and a search result type; and generate, based on the search term and the search result type, second information corresponding to the target information platform; and the display module 430 is further configured to send the second information to the target information platform; and display, in the interaction interface between the user and the agent, a search result obtained by the target information platform based on the second information as the target multimedia resource.

In some embodiments, the second information is also displayed in the target information platform, the receiving module 410 is further configured to receive a modification of the second information by the user; and the display module 430 is further configured to send modified second information to the target information platform; and display, in the interaction interface between the user and the agent, a search result obtained by the target information platform based on the modified second information.

In some embodiments, the receiving module 410 is further configured to receive question information input by the user for one or more multimedia resources in the target multimedia resource; the interaction apparatus further includes a generation module 440 configured to generate an answer based on the question information and the one or more multimedia resources; and the display module 430 is further configured to display the answer in the interaction interface between the user and the agent.

FIG. 5 shows a block diagram of an electronic device according to some embodiments of the present disclosure.

The memory 51 is configured to store one or more computer-readable instructions. The memory 51 may include any combination of various forms of computer-readable storage media, such as a volatile memory and/or a non-volatile memory, including but not limited to a random access memory (RAM), a dynamic random access memory (DRAM), a static random access memory (SRAM), a read-only memory (ROM), and a flash memory. For example, the memory 51 may store an operating system, an application, a boot loader, a database, other programs, or the like, and may also store various applications, various data, or the like.

The processor 52 is configured to run the computer-readable instructions to implement the interaction method according to any one of the previous embodiments. For the specific implementation of each step of the method, reference may be made to the above embodiments, and repeated parts are not described herein.

The processor 52 may be configured to perform the steps in FIG. 1 to FIG. 3. The processor 52 may be embodied as various processing apparatuses, such as a central processing unit (CPU) and a network processor (NP); and may also be a digital signal processor (DSP), an application specific integrated circuit (ASIC), a field programmable gate array (FPGA) or another programmable logic device, a discrete gate or transistor logic device, or a discrete hardware component. The central processing unit (CPU) may have an X86 or ARM architecture or the like.

The processor 52 and the memory 51 may directly or indirectly communicate with each other. For example, the processor 52 and the memory 51 may communicate through a network. The network may include a wireless network, a wired network, and/or any combination of a wireless network and a wired network. The processor 52 and the memory 51 may also communicate with each other through a system bus, which is not limited in the present disclosure.

It is to be noted that the components of the electronic device 5 shown in FIG. 5 are merely exemplary and non-restrictive, and the electronic device 5 may have other components according to actual application needs. The processor 52 may control other components in the electronic device 5 to perform desired functions.

The electronic device 5 may be implemented by software, firmware, and/or hardware, and may be integrated into an apparatus in which a related application is installed.

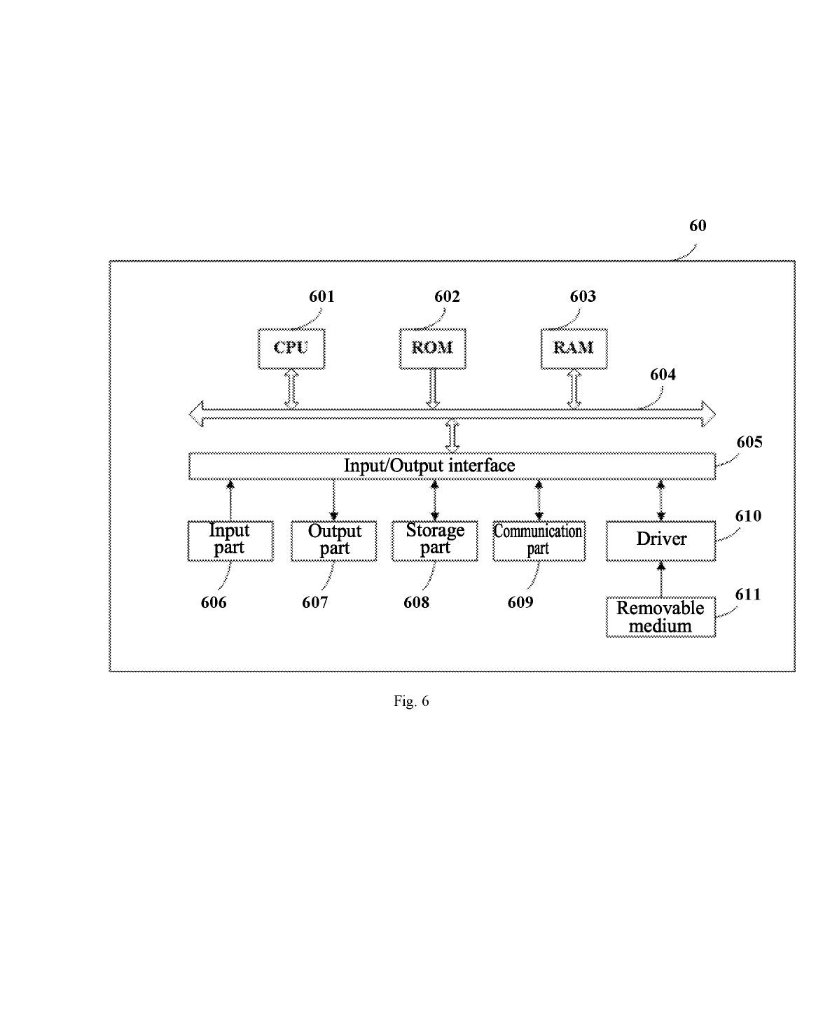

FIG. 6 shows a block diagram of an electronic device according to some other embodiments of the present disclosure.

The electronic device 6 shown in FIG. 6 may be a computer system having a dedicated hardware structure, and may perform corresponding functions when a related application is installed.

The electronic device includes but is not limited to mobile terminals such as smart phones, notebooks, personal digital assistants (Personal Digital Assistant, PDA), tablet personal computers (Tablet Personal Computer, Tablet PC), portable multimedia players (PMP), vehicle terminals (such as car navigation terminals), and wearable devices, and fixed terminals such as digital TVs and desktop computers.

As shown in FIG. 6, a central processing unit (CPU) 61 performs various processes based on a program stored in a read-only memory (ROM) 62 or a program loaded from a storage unit 68 into a random access memory (RAM) 63. The RAM 63 stores data required when the CPU 61 performs various processes and the like as needed. The central processing unit is merely exemplary, and it may be other types of processors, such as the various processors mentioned above. The ROM 62, the RAM 63, and the storage unit 68 may be various forms of computer-readable storage media. It is to be noted that although the ROM 62, the RAM 63, and the storage unit 68 are shown separately in FIG. 6, one or more of them may be combined or located in the same or different memories or storage modules.

The CPU 61, the ROM 62, and the RAM 63 are connected to each other via a bus 64. An input/output interface 65 is also connected to the bus 64.

The following components are connected to the input/output interface 65: an input unit 66 such as a touch screen, a touchpad, a keyboard, a mouse, an image sensor, a microphone, an accelerometer, and a gyroscope; an output unit 67 including a display such as a cathode ray tube (CRT) and a liquid crystal display (LCD), a speaker, a vibrator, or the like; the storage unit 68 including a hard disk, a magnetic tape, or the like; and a communication unit 69 including a network interface card such as a LAN card and a modem. The communication unit 69 allows communication processing to be performed via a network such as the Internet. It is easily understood that although some components in the electronic device 6 shown in FIG. 6 communicate through the bus 64, they may also communicate through a network or other means, where the network may include a wireless network, a wired network, and/or any combination of a wireless network and a wired network.

A driver 610 is also connected to the input/output interface 65 as needed. A removable medium 611 such as a magnetic disk, an optical disc, a magneto-optical disc, and a semiconductor memory is installed on the driver 610 as needed, so that a computer program read therefrom is installed in the storage unit 68 as needed.

In the case where the above series of processes are implemented by software, a program constituting the software may be installed from a network such as the Internet or a storage medium such as the removable medium 611.

According to the embodiments of the present disclosure, the process described above with reference to the flowchart may be implemented as a computer software program. For example, some embodiments of the present disclosure include a computer program product that, when running on a computer, causes the computer to implement the method according to any one of the previous embodiments. The computer program product includes computer instructions carried on a computer-readable medium, and includes program code for performing the method shown in the flowchart. In such an embodiment, the computer instructions may be downloaded and installed from a network through the communication unit 69, or installed from the storage unit 68, or installed from the ROM 62. When the computer program is executed by the CPU 61, the method in the embodiments of the present disclosure is executed.

It is to be noted that in the context of the present disclosure, the computer-readable medium may be a tangible medium that may include or store a program for use by or in combination with an instruction execution system, apparatus, or device.

The computer-readable medium may be a computer-readable storage medium, a computer-readable signal medium, or any combination thereof.

The computer-readable storage medium includes but is not limited to an electrical, magnetic, optical, electromagnetic, infrared, or semiconductor system, apparatus, or device, or any suitable combination thereof. More specific examples of the computer-readable storage medium may include but are not limited to: an electrical connection having one or more wires, a portable computer magnetic disk, a hard disk, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or device. The computer-readable storage medium has computer instructions stored thereon, and the instructions, when executed by a processor, implement the method according to any one of the previous embodiments.

The computer-readable signal medium may include a data signal propagated on a baseband or as a part of a carrier, and computer-readable program code is carried in the data signal. The data signal propagated in this manner may be in multiple forms, and includes but is not limited to an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted by any suitable medium, including but not limited to a wire, an optical cable, a radio frequency (RF), or any suitable combination thereof.

The computer-readable medium may be contained in the electronic device or may exist alone without being assembled into the electronic device.

In some embodiments, there is further provided a computer program including instructions that, when executed by a processor, cause the processor to perform the method according to any one of the previous embodiments. For example, the instructions may be embodied as computer program code.

In the embodiments of the present disclosure, the computer program code for performing the operations of the present disclosure may be written in one or more programming languages or a combination thereof, where the programming languages include but are not limited to object-oriented programming languages such as Java, Smalltalk, and C++, and further include conventional procedural programming languages such as "C" language or similar programming languages. The program code may be completely executed on a user computer, partially executed on a user computer, executed as an independent software package, partially executed on a user computer and partially executed on a remote computer, or completely executed on a remote computer or server. In the case involving a remote computer, the remote computer may be connected to the user computer through any kind of network (including a local area network (LAN) or a wide area network (WAN)), or may be connected to an external computer (for example, connected by using Internet provided by an Internet service provider).

The flowchart and block diagram in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It is also to be noted that, in some alternative implementations, the functions marked in the blocks may also occur in an order different from that marked in the drawings. For example, two blocks shown in succession may actually be performed substantially in parallel, or they may sometimes be performed in the reverse order, depending upon the functionality involved. It is also to be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The functions described above may be at least partially performed by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), etc.

Although some specific embodiments of the present disclosure have been described in detail by way of example, those skilled in the art should understand that the above examples are only for illustration, and are not intended to limit the scope of the present disclosure. Those skilled in the art should understand that the above embodiments may be modified without departing from the scope and spirit of the present disclosure. The scope of the present disclosure is defined by the appended claims.

What is claimed is:

1. An interaction method, comprising:
receiving first information input by a user in an interaction interface with an agent;
determining, based on the first information, a target information platform matching the first information, wherein the target information platform comprises a target multimedia resource matching demand information corresponding to the first information; and
displaying the target multimedia resource in the interaction interface between the user and the agent.

2. The interaction method of claim 1, wherein the determining, based on the first information, a target information platform matching the first information comprises:
determining, based on semantic information of the first information, the demand information corresponding to the first information; and
determining, based on the demand information, the target information platform matching the demand information.

3. The interaction method of claim 2, wherein the determining, based on semantic information of the first information, the demand information corresponding to the first information comprises:
determining, based on the semantic information of the first information, basic demand information corresponding to the first information;
expanding the basic demand information to obtain expanded demand information; and
determining at least one of the basic demand information or the expanded demand information as the demand information.

4. The interaction method of claim 3, wherein the basic demand information corresponds to a first demand category, the expanded demand information corresponds to a second demand category, and the determining, based on the demand information, the target information platform matching the demand information comprises:
determining an information platform corresponding to at least one of the first demand category or the second demand category as the target information platform.

5. The interaction method of claim 2, wherein the determining, based on the demand information, the target information platform matching the demand information comprises:
obtaining index information of a plurality of information platforms, wherein the index information comprises summary information of multimedia resources of each of the plurality of information platforms; and
determining, based on semantic information of the demand information and the summary information of the multimedia resources of each of the plurality of information platforms, the target information platform matching the demand information from the plurality of information platforms.

6. The interaction method of claim 1, wherein the interaction interface between the user and the agent comprises a first column and a second column, reply information generated based on the first information is displayed in the first column, and the target multimedia resource is displayed in the second column.

7. The interaction method of claim 6, wherein a generation control is displayed in the first column, and the interaction method further comprises:
generating, based on one or more multimedia resources , target content, in response to a selection operation of the user on the one or more multimedia resources in the target multimedia resource and a trigger operation of the user on the generation control; and
displaying the target content in the first column.

8. The interaction method of claim 6, further comprising:
displaying a generation control on an upper layer of the second column, in response to a selection operation of the user on one or more multimedia resources in the target multimedia resource;
generating, based on the one or more multimedia resources, target content, in response to a trigger operation of the user on the generation control; and
displaying the target content in the first column.

9. The interaction method of claim 7, wherein the generation control comprises a control configured to summarize the one or more multimedia resources, and the generating, based on one or more multimedia resources, the target content comprises:
summarizing, based on semantic information of the one or more multimedia resources, the one or more multimedia resources to generate summary information as the target content.

10. The interaction method of claim 7, wherein the one or more multimedia resources comprise a plurality of multimedia resources, the generation control comprises a control configured to compare the plurality of multimedia resources, and the generating, based on one or more multimedia resources, the target content comprises:
comparing, based on semantic information of the plurality of multimedia resources, the plurality of multimedia resources to generate comparison information as the target content.

11. The interaction method of claim 6, further comprising:
receiving prompt information input by the user in the first column or the second column, wherein the prompt information comprises selection information of one or more multimedia resources in the target multimedia resource;
generating, based on the prompt information and the one or more multimedia resources, target content; and
displaying the target content in the first column.

12. The interaction method of claim 11, wherein the prompt information comprises information indicating a reference part of each of the one or more multimedia resources and at least one of a theme or a type of the target content, and the generating, based on the prompt information and the one or more multimedia resources, the target content comprises:
determining, based on semantic information of the prompt information and each of the one or more multimedia resources, the reference part of each of the one or more multimedia resources; and
summarizing, based on at least one of the theme or the type of the target content and semantic information of the reference part of each of the one or more multimedia resources, the one or more multimedia resources to generate the target content.

13. The interaction method of claim 1, wherein the displaying the target multimedia resource in the interaction interface between the user and the agent comprises:
determining, based on semantic information of the first information, a search term and a search result type;
generating, based on the search term and the search result type, second information corresponding to the target information platform;
sending the second information to the target information platform; and
displaying, in the interaction interface between the user and the agent, a search result obtained by the target information platform based on the second information as the target multimedia resource.

14. The interaction method of claim 13, wherein the second information is also displayed in the target information platform, and the interaction method further comprises:
receiving a modification of the second information by the user;
sending modified second information to the target information platform; and
displaying, in the interaction interface between the user and the agent, a search result obtained by the target information platform based on the modified second information.

15. The interaction method of claim 1, further comprising:
receiving question information input by the user for one or more multimedia resources in the target multimedia resource;
generating, based on the question information and the one or more multimedia resources, an answer; and
displaying the answer in the interaction interface between the user and the agent.

16. An electronic device, comprising:
a processor; and
a memory coupled to the processor and configured to store instructions, wherein the instructions, when executed by the processor, cause the processor to:
receive first information input by a user in an interaction interface with an agent;
determine, based on the first information, a target information platform matching the first information, wherein the target information platform comprises a target multimedia resource matching demand information corresponding to the first information; and
display the target multimedia resource in the interaction interface between the user and the agent.

17. The electronic device according to claim 16, wherein the determining, based on the first information, a target information platform matching the first information comprises:
determining, based on semantic information of the first information, the demand information corresponding to the first information; and
determining, based on the demand information, the target information platform matching the demand information.

18. The electronic device according to claim 17, wherein the determining, based on semantic information of the first information, the demand information corresponding to the first information comprises:
determining, based on the semantic information of the first information, basic demand information corresponding to the first information;
expanding the basic demand information to obtain expanded demand information; and
determining at least one of the basic demand information or the expanded demand information as the demand information.

19. A non-transitory computer-readable storage medium, wherein a computer program is stored on the computer-readable storage medium, and the computer program, when executed by a processor, causes the processor to:
receive first information input by a user in an interaction interface with an agent;
determine, based on the first information, a target information platform matching the first information, wherein the target information platform comprises a target multimedia resource matching demand information corresponding to the first information; and
display the target multimedia resource in the interaction interface between the user and the agent.

20. The non-transitory computer-readable storage medium according to claim 19, wherein the determining, based on the first information, a target information platform matching the first information comprises:
determining, based on semantic information of the first information, the demand information corresponding to the first information; and
determining, based on the demand information, the target information platform matching the demand information.
